(19) United States
(12) Patent Application Publication
(10) Pub. No.: US 2018/0025278 A1
(43) Pub. Date: Jan. 25, 2018

(54) SYSTEM AND METHOD FOR FUELING LOCATION RECOMMENDATIONS

(71) Applicant: ExxonMobil Research and Engineering Company, Annandale, NJ (US)

(72) Inventors: Gregory K. Lilik, Media, PA (US); Mike T. Noorman, Cinnaminson, NJ (US); Leonard R. Koenig, Jobstown, NJ (US)

(21) Appl. No.: 15/636,802

(22) Filed: Jun. 29, 2017

Related U.S. Application Data
(60) Provisional application No. 62/365,631, filed on Jul. 22, 2016.

(51) Int. Cl. G06N 5/04; G07C 5/08; G01C 21/36

(52) U.S. Cl. CPC G06N 5/04; G01C 21/3682; G07C 5/085

(57) ABSTRACT

A system for providing fuel location recommendations can include a vehicle data receiver configured to receive vehicle data from a vehicle computer, navigational system, and/or a vehicle operator, a fuel characteristic module configured to receive fuel properties of one or more fuel batches from a fuel property database, and a recommendation module configured to determine one or more recommended locations for refueling the vehicle based on received vehicle data from the vehicle data receiver and received fuel properties from the fuel property database.

### CROSS-REFERENCE TO RELATED APPLICATIONS

This application claims the benefit of U.S. Provisional Application No. 62/365,631, filed on Jul. 22, 2016, the entire contents of which are incorporated herein by reference.

### FIELD

This disclosure relates generally to purchasing fuel, and more particularly to a system and method for providing fueling location recommendations to vehicle operators.

### BACKGROUND

Information and interactive mobile services available to vehicles are increasing due to the demand of vehicle operators for services such as navigation assistance, directory assistance, vehicle maintenance assistance, roadside assistance, information services assistance and emergency assistance. Requests for many of these services occur when a vehicle is outside of a home region, for example, during personal travel or business trips to neighboring or distant cities. Presently, on-board diagnostic (OBD) systems are incorporated into all modern vehicles, and provide an electronic solution for controlling, diagnosing, and reporting the operating state of the vehicle.

In general, the fuel market has one grade of diesel fuel and multiple grades of gasoline based on octane rating, varying between about 87 and about 94 AKI. Fuel offerings are often differentiated by retail fueling sites by bulk additizing the fuel with an additive package. At pump additization technologies are also in the market and allow the consumers to select the additives they believe will enhance vehicle performance. Additives can also be added from bottles per the consumers' prerogative.

Variability in the fungible fueling supply has been viewed as a hindrance, (i.e. the energy density, cetane number or cloud point of diesel fuel can vary from fuel station to fuel station). Also, a vehicle's fueling need may vary due to engine technology, vehicle age, vehicle type, style in which the vehicle is driven and ambient conditions.

A way to account for and/or utilize such inherent variability in fuel supply is needed.

### SUMMARY

In accordance with at least one aspect of this disclosure, a system for providing fuel location recommendations can include a vehicle data receiver configured to receive vehicle data from a vehicle computer, navigational system, and/or a vehicle operator, a fuel characteristic module configured to receive fuel properties of one or more fuel batches from a fuel property database, and a recommendation module configured to determine one or more recommended locations for refueling the vehicle based on received vehicle data from the vehicle data receiver and received fuel properties from the fuel property database.

The vehicle data can include at least one of fuel tank volume, fuel level, vehicle speed, vehicle load, fuel consumption rate, range, odometer reading, engine performance, vehicle performance history, one or more ambient conditions, vehicle make, vehicle model, specific drivetrain information, performance related vehicle modifications, an operator profile, location, or destination. Any other suitable vehicle data is contemplated herein.

The vehicle data receiver can be configured to be connected to a data port of the vehicle. In certain embodiments, the vehicle data receiver and/or any other component of the system can be integrated into the vehicle by the manufacturer, for example.

The vehicle data receiver can include a memory and a processor configured to execute computer readable instructions on stored on the memory. The fuel characteristic module and the recommendation module can be embodied as software modules in the form of computer readable instructions stored on the memory of the vehicle data receiver and configured to be executed by the processor.

The vehicle data receiver can be operatively connected to the navigational system to output a recommended fueling location to the navigational system to display the recommended fueling location to the vehicle operator. In certain embodiments, the vehicle data receiver can be configured to be wirelessly connected to a mobile device. For example, the fuel characteristic module and the recommendation module can be embodied as software modules in the form of computer readable instructions stored on a memory of the mobile device such that the recommendation module is configured to output a recommended fueling location to a mobile navigational system of the mobile device.

The vehicle data receiver can be configured to be wirelessly connected to a mobile device. In certain embodiments, the fuel properties database can be stored on a remote server and/or in the cloud and is updated in real time.

In another aspect of this disclosure a system for recommending fueling locations to a user of a vehicle can include a plurality of fuel property sensors deployed in a plurality of locations, each sensor operatively configured to sense at least one of a fuel quality of a batch of fuel or an ambient condition around or near the batch of fuel. The sensors are communicatively connected to a fuel property database to output the fuel quality and/or ambient condition to the fuel property database.

The system can further include a server including a server processor and a server memory, wherein the fuel property database is stored on the server memory, wherein the server processor is communicatively connected to the plurality of fuel property sensors. In certain embodiments, the fuel property database can be stored on the cloud and each sensor can be connected to the internet.

In another aspect of this disclosure, a computer implemented method for recommending one or more fueling locations can include receiving, at a processor, vehicle data including at least one of fuel tank volume, fuel level, vehicle speed, vehicle load, fuel consumption rate, range, odometer reading, engine performance, vehicle performance history, one or more ambient conditions, vehicle make, vehicle model, specific drivetrain information, performance related vehicle modifications, an operator profile, location, destination, or any other suitable data. The method can further include receiving, at the processor, one or more fuel properties of one or more batches of fuel from a fuel properties database, and providing a recommended fueling location to an operator of the vehicle based on the received vehicle data and the received one or more fuel properties to optimize vehicle performance.

Receiving vehicle data can include receiving a vehicle location and/or destination from a navigational system. In certain embodiments, the method can include providing a recommended fuel type and/or additive based on the vehicle data and/or the one or more fuel properties.

The method can include communicating with a fuel dispenser to send the recommended fuel type and/or additive to a fuel pump to cause the fuel pump to provide the vehicle with fuel having the recommended fuel type and/or additive. Providing a recommended fueling location can include providing one or more locations within a predetermined range of the vehicle based on fuel level and fuel consumption rate.

Providing the recommended fueling location can include displaying one or more fueling locations on a graphical user interface (GUI). Displaying the one or more recommended fueling locations on a GUI can include displaying the one or more recommended fueling locations on a display of a navigational system of a vehicle or on a mobile device display.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1A illustrates a schematic diagram view of an embodiment of a fueling location recommendation system constructed in accordance with this disclosure;

FIG. 1B illustrates a schematic diagram view of an embodiment of a fueling location recommendation system constructed in accordance with this disclosure;

FIG. 2 is an exemplary block diagram of vehicle data receiver components in accordance with an illustrative embodiment; and

FIG. 3 illustrates an exemplary method as described herein.

### DETAILED DESCRIPTION

All numerical values within the detailed description and the claims herein are modified by “about” or “approximately” the indicated value, and take into account experimental error and variations that would be expected by a person having ordinary skill in the art.

The present disclosure is now described more fully with reference to the accompanying drawings, in which illustrated embodiments of the present disclosure are shown wherein like reference numerals identify like elements. The present disclosure is not limited in any way to the illustrated embodiments as the illustrated embodiments described below are merely exemplary of the disclosure, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present disclosure. Furthermore, the terms and phrases used herein are not intended to be limiting but rather to provide an understandable description of the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, exemplary methods and materials are now described. It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the embodiments of this disclosure as discussed below are preferably a software algorithm, program or code residing on computer useable medium having control logic for enabling execution on a machine having a computer processor. The machine typically includes memory storage configured to provide output from execution of the computer algorithm or program.
1. As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described below. One skilled in the art will appreciate further features and advantages of the disclosure based on the below-described embodiments. Accordingly wherein the turbine oil has an evaporative weight loss at 204° C. for 6.5 hours per ASTM D972 of less than 3.2 wt. %.
2. The turbine oil of claim 14, wherein the turbine oil has a TGA-simulated Noack volatility of less than evaporation loss per ASTM D972 of less than 3.1 wt. %.
3. The turbine oil of claim 14, wherein the turbine oil has a GC-simulated distillation volatility at 10% weight loss of greater than 800 deg. F.

The disclosure is not to be limited by what has been particularly shown and described, except as indicated by the appended claims.

In exemplary embodiments, a computer system component may constitute a “module” that is configured and operates to perform certain operations as described herein below. Accordingly, the term “module” should be understood to encompass a tangible entity, be that an entity that is physically constructed, permanently configured (e.g., hardwired) or temporarily configured (e.g. programmed) to operate in a certain manner and to perform certain operations described herein.

Optimal engine performance typically requires a combination of conflicting requirements. High output (e.g., high torque, acceleration, power, or brake horsepower), efficiency (low fuel consumption or miles travelled per gallon) and low emissions (such as NOx and CO₂ emissions) are simultaneously desired, but not to the extent of damaging or otherwise degrading the engine, environment, and/or users. In other words, high engine performance should be within safety limits, efficiency should be balanced with the performance needs, such as rapidly merging into fast-moving traffic. The combination of these competing demands generally leads to a fuel recommendation of sub-optimal performance that is well within limits and based on some “average” or “typical” driving.

An engine operating condition (e.g., load, speed, air temperature, pressure, humidity, Brake Mean Effective Pressure (BMEP), boost, fuel/air ratio, ignition timing, injection timing, Exhaust Gas Recirculation (EGR) rate, compression ratio, and the like) may affect performance. Within an operating condition, safe operation is typically associated with controlled combustion (e.g., from a combustion front ignited by a spark plug or a fuel injection). A “high output” operating condition often increases the likelihood of uncontrolled combustion, which may be damaging.

In the example of a gasoline fueled spark ignited vehicles, abnormal combustion (or knocking, pinging, pinking, detonation), is a combustion event in which an uncontrolled explosion occurs within the cylinder. As appreciated by those skilled in the art, a diesel cycle engine can also experience one or more abnormal combustion scenarios. Typically knocking comprises an instantaneous, explosive ignition of a pocket of fuel/air mixture outside of the controlled combustion zone (e.g., ahead of the flame front). A local shockwave is created around the pocket and the cylinder pressure may rise sharply. In extreme cases, engine parts can be damaged or destroyed. There is a degree of variability associated with combustion, which may result in a range of “intensities” for a knocking event. A “low” or “mild” knock may not be harmful, while a “high” or “harsh” knock may cause damage. Knocking at least partially results from a stochastic or otherwise random influences on an otherwise normally operating engine. As such, engine operation typically yields a range of intensities of knocking events.

Substantially all newly manufactured motor vehicles including trucks, automobiles, motorcycles, and boats that are powered by spark ignited and/or diesel cycle engines are equipped with an Electronic Control Unit (ECU) or similar automatic engine control components. The ECU controls the mixture ratio of fuel (typically gasoline or mixtures of gasoline and oxygenates) and oxygen at the fuel injectors or carburetor, as is present at the time of combustion in the cylinder chamber of the engine, and can adjust the engine spark timing (e.g., in a spark ignition engine) and possibly valve timing accordingly, to prevent high knocking events that can damage the engine. It is well understood that using knock resistant, high octane fuel will allow many modern vehicles to take advantage of more aggressive tuning and associated efficiency and performance benefits. The ratio of oxygen to gasoline at the time of ignition is called the stoichiometry of the mixture, which can vary depending on engine design. The ECU maintains this mixture stoichiometry by monitoring several key elements, fundamental to all combustion engines, i.e. exhaust gas temperature, exhaust oxygen levels, throttle position, rpm's, torque, power requirements, engine temperature, manifold absolute pressure (MAP), outside air temperature and humidity, as well as other factors.

The combination of vehicle and engine can result in specific requirements for octane/cetane (e.g., fuel anti-knock rating) that depend on the fuel composition for gasoline and/or diesel. For example, a multitude of fuel compositions with varying boiling ranges are rated as regular gasoline (87 (RON+MON)/2). Older-calibrated vehicles originally designed to run on regular gasoline can develop performance robbing deposits (“octane requirement increase”) that can be compensated by higher octane fuel.

In modern vehicles, the computer (ECU) includes a knock control system configured and operable to list for engine knocking, and adjust (“detune”) the engine parameters (i.e., ignition timing, valve timing, etc.) according to a precise set of numbers loaded into a look-up table within the ECU, designed by the manufacturer of the vehicle. However, at least in some cases, when operating an engine and adjusting engine operation, the traditional knock control systems within ECUs may choose to sacrifice vehicle performance or efficiency, by “detuning” of the engine, to avoid dangerous knock events. This automatic detuning routine designed to adjust engine's operational parameters in order to prevent harm does not offer vehicle operators any information and/or feedback with respect to making choices in their fuel purchases to improve specific performance related parameters (i.e., efficiency, power, etc.).

Various embodiments of the present disclosure disclose a fueling location recommendation systems configured and operable to provide relevant information related to fuel products and fueling services that satisfy user-specified needs. Advantageously, fueling at a recommended fueling location based on certain factors can improve efficiency, prolong vehicle life, potentially increased resale value of vehicle, for example. Embodiments of the fueling location recommendation system can dynamically provide recommendations based on the performed (e.g., real-time) analysis of the vehicle operating data, environmental data, operator profile (e.g., including usage and driving patterns).

The monitoring of vehicle performance parameters (the terms “vehicle performance parameters” and “vehicle operational data” may be used interchangeably and include: vehicle speed, vehicle location, engine speed, engine load, air temperature, and fuel use, noting that such parameters are exemplary and not limiting) is done in real-time, via a recommendation module remote from the vehicle and optionally hosted by the cloud-based platform (where vehicle operational data is conveyed from the vehicle to the cloud-based platform in real-time). The term “real-time” as used herein and the claims that follow is not intended to imply the data is analyzed or transmitted instantaneously, rather the data is collected over a relatively short period of time (over a period of seconds or minutes), and analyzed (or transmitted to the remote computing device (i.e., cloud-based platform) on an ongoing basis and analyzed) in a compressed time frame, as opposed to storing the data at the vehicle or remotely for an extended period of time (hour or days) before analysis. In certain embodiments, this real-time analysis may produce a relationship between fuel composition, location, and vehicle performance parameters, for example. This relationship may be presented to a user as part of relevant information related to recommended fuel products.

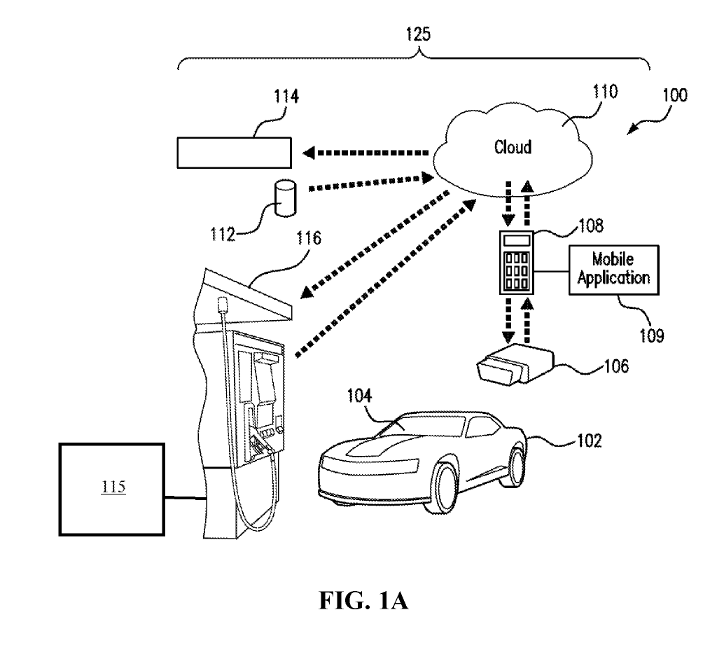

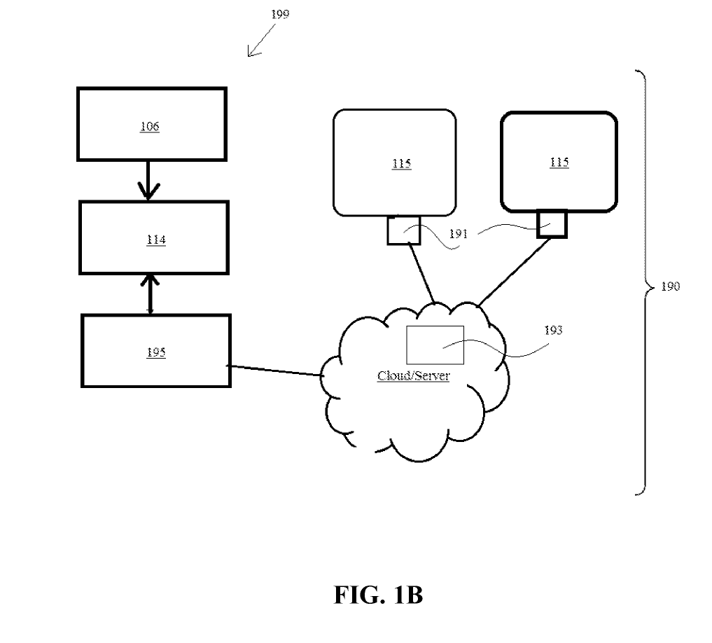

The fueling location recommendation system disclosed herein can provide vehicle fuel recommendation services to a mobile application accessible at a customer's mobile device associated with a customer's vehicle or the vehicle's data port (e.g., J1962). Referring to FIGS. 1A and 1B, various devices can communicate with each other and/or with a cloud based platform 125, discussed in greater detail below. Certain embodiments illustrated herein include a method that may be practiced in a cloud-based computing environment.

Smart fueling techniques, which are optionally provided by the fueling location recommendation system 100 can create an environment that supports communication amongst the vehicle 102 (which includes the vehicle's integrated head-unit display), a vehicle data receiver 106, an independent user mobile device 108 (e.g., a mobile phone, tablet, computing device, wearable device, etc.), and a smart fuel dispenser 116. Notably, various communications options exist amongst each of these devices. For example, each of the vehicle 102, vehicle data receiver 106, mobile device 108, and fuel dispenser 116 can communicate directly with each other and/or can communicate through the cloud 110.

Although fuel dispenser 116 is shown as a physical standalone fueling station, it is expressly contemplated that fuel dispenser 116 can be part of and communicate with a larger distributed fuel delivery system.

As discussed herein, the vehicle 102 can include vehicle telematics data either directly obtained from the vehicle telematics data infrastructure including one or more data ports (e.g., J1962) and/or vehicle information and control systems 104 that generate telematics data, including vehicle diagnostic data. With respect to telematics data, generally telematics represents a mix of hardware and software telecommunications technology that conveys data or information for the purpose of improving business services or functions. In the automotive space, telematics has evolved to also include vehicle diagnostic data, vehicle performance data, global positioning satellite (GPS) data corresponding to the vehicle, support services data and the like.

In accordance with at least one aspect of this disclosure, as shown in FIG. 1B, a system 199 for providing fuel location recommendations can include a vehicle data receiver 106 configured to receive vehicle data from a vehicle computer, navigational system, and/or a vehicle operator. The system 199 also includes a fuel characteristic module 195 configured to receive fuel properties of one or more fuel batches 115 from a fuel property database 193.

The system 199 includes a recommendation module 114 configured to determine one or more recommended locations for refueling the vehicle based on received vehicle data from the vehicle data receiver 106 and received fuel properties from the fuel property database 193. Each module can include any suitable electronics hardware and/or software as appreciated by those having ordinary skill in the art. The modules can each be separate or combined together in a single unit (e.g., the vehicle data receiver 106).

The vehicle data can include at least one of fuel tank volume, fuel level, vehicle speed, vehicle load, fuel consumption rate, range, odometer reading, engine performance, vehicle performance history, one or more ambient conditions, vehicle make, vehicle model, specific drivetrain information, performance related vehicle modifications, an operator profile, location, or destination. Any other suitable vehicle data is contemplated herein.

The vehicle data receiver 106 can be configured to be connected to a data port of the vehicle, as described herein. In certain embodiments, the vehicle data receiver 106 and/or any other component of the system can be integrated into the vehicle by the manufacturer, for example.

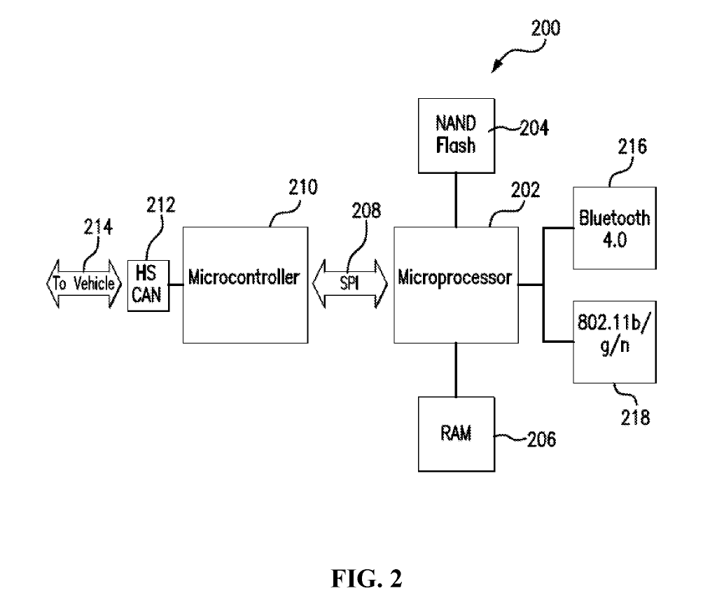

The vehicle data receiver 106 can include a memory and a processor configured to execute computer readable instructions on stored on the memory, and/or any other features as described below with respect to FIG. 2. The fuel characteristic module 195 and the recommendation module 114 can be embodied as software modules in the form of computer readable instructions stored on the memory of the vehicle data receiver 106 and configured to be executed by the processor.

The vehicle data receiver 106 can be operatively connected to the navigational system (e.g., of the vehicle or a mobile device) to output a recommended fueling location to the navigational system to display the recommended fueling location to the vehicle operator. In certain embodiments, the vehicle data receiver 106 can be configured to be wirelessly connected to a mobile device 108. For example, the fuel characteristic module 195 and the recommendation module 114 can be embodied as software modules in the form of computer readable instructions stored on a memory of the mobile device 108 such that the recommendation module is configured to output a recommended fueling location to a mobile navigational system of the mobile device 108.

In certain embodiments, one or more of the fuel characteristics module 195 and/or the recommendation module 114 can be remote from the vehicle 102 and connected through the cloud 110 (and/or any other suitable relay/server). In such embodiments, the recommendation module 114 can receive vehicle data through the cloud 110 or other server and also receive fuel property data from the fuel property database 193 through the cloud, calculate recommended locations, and send the recommended locations back to the vehicle data receiver 106, the users mobile device 108, or any other suitable interface through the cloud 110 or other suitable server.

The vehicle data receiver 106 can be configured to be wirelessly connected to the mobile device 108, for example. In certain embodiments, the fuel properties database can be stored on a remote server and/or in the cloud 110 and is updated in real time.

In another aspect of this disclosure a system 190 for recommending fueling locations to a user of a vehicle can include a plurality of fuel property sensors 191 disposed in a plurality of locations. Each sensor 191 is operatively configured to sense at least one of a fuel quality (e.g., temperature, pressure, chemical composition) of a batch 115 of fuel or an ambient condition (e.g., temperature, barometric pressure, humidity, weather patterns, forecast weather conditions) around or near the batch of fuel 115. The sensors 191 can include any suitable sensors (e.g., resistive fuel sensors, infrared, mass spectrometry sensors). The sensors 191 are communicatively connected to a fuel property database 193 to output the fuel quality and/or ambient condition to the fuel property database 193.

Fuel property database 193 can also receive data from various sources, e.g., refinery gate, sales, terminal, station tankage sensors, dispensers, or any other suitable source. The fuel property database 193 does not need to be embodied as a single database and can be comprised of any suitable components and/or data sources.

The system 190 can further include a server having a server processor and a server memory and the fuel property database can be stored on the server memory. In such an embodiment, the server processor is communicatively connected to the plurality of fuel property sensors 191 (e.g., via wireless connection/relays, via internet). In certain embodiments, the fuel property database 193 can be stored on the cloud and each sensor 193 can be connected to the internet to communicate with the fuel property database 193.

In certain embodiments, information related to a plurality of fuel products/batches 115 and fuel dispensing services may be provided by a cloud-based platform 125 storing service consumer's information as well as collected vehicle related data (i.e., vehicle operational data) in one or more databases 112. The cloud-based platform 125 may further include a telematics Application Programming Interface (API) (not shown in FIG. 1A). The telematic API may include an Oauth API. OAuth is a protocol that allows applications developed by third-parties to access a service consumer's account. Within the OAuth workflow, the consumer/user is redirected from the mobile application 109 to an authentication endpoint for the cloud service, where the user provides authentication credentials and authorizes access by the mobile application 109. This process enables the third party application (i.e., mobile application 109) to access a vendor provided service (e.g., recommendation module 114) without requiring the user to share their authentication credentials with the mobile application 109. In an embodiment of the present disclosure, the recommendation module 114 may be configured to analyze collected data related to vehicle performance in real-time and configured to provide an enhanced fuel type recommendation service and intended to achieve at least one of 1) maximized engine efficiency; 2) improved fuel economy; 3) improved vehicle performance depending on users' preferences.

In certain embodiments, an end user may request delivery of a fueling location recommendation service through the mobile application 109 running on the respective user mobile device 108. The user mobile device 108 could be a handheld computer, mobile Internet appliance, smartphone, connected vehicle, or any other mobile device that can be associated with end user's vehicle 102 and capable of receiving and processing fuel recommendation information. It is also contemplated that the fueling location recommendations can be made automatically when the fuel level of the vehicle 102 reaches a predetermined level such that recommendation module 114 receives a fuel level from the vehicle data receiver 106 and is prompted to output one or more recommendations.

The vehicle control system 104 shown in FIG. 1A includes at least one vehicle data port, which can be a J1962 port for a car, for example, for OBD-II standard but may be any other suitable data ports. In the embodiment depicted in FIG. 1A, a wireless interface connects the data port of the vehicle control system 104 to an intelligent vehicle data receiver 106. Further, in the embodiment depicted in FIG. 1A, the mobile device 108 is also wirelessly connected to the vehicle data receiver 106.

It is appreciated that even though the illustrated embodiment shows the recommendation module 114 being hosted by the cloud-based platform 112, the recommendation module 114 is equally adaptable to be hosted elsewhere. For example, in certain embodiments, the recommendation module 114 may run on the user mobile device 108, while in yet another embodiment the recommendation module 114 may be hosted by the vehicle control system 104.

The vehicle data receiver 106 may be any of a number of items, such as a specialized standalone transceiver, a laptop computer with specialized software and communications protocols loaded thereon, a specialized OBD port dongle (e.g., for a J1962 port), or other specialized appliance.

Referring to FIG. 2, a schematic block diagram provides an overview of some components inside an embodiment of a vehicle data receiver in accordance with embodiments of the present disclosure. As noted above, the vehicle data receiver 106 is a specialized transceiver unit communicatively coupled to the vehicle 102, capable of accessing vehicle performance data, among other data, and capable of performing efficient compression for the storage and wireless transmission of acquired data. A vehicle data receiver 200 shown in FIG. 2 is similar to the vehicle data receiver 106 in FIG. 1A, except that the vehicle data receiver 200 also illustrates and highlights selected internal components including one or more wireless communication modules 216 and 218, a head unit processor 202 with associated memory including a nonvolatile random access memory (RAM) 206 and a NAND flash memory 204, and a microcontroller 210. In certain embodiments, the head unit processor 202 can be, for example, a Texas Instruments AM3703 Sitara ARM microprocessor while the microcontroller 210 can be any suitable CAN microcontroller. The NAND flash memory 204 may perform program, read, and erase operations according to the control of the head unit processor 202.

For the transmitting and receiving of data between various components, the head unit processor 202 can also be associated with serial peripheral interface (SPI) 208. For example, the head unit processor 202 may communicate, over SPI 208, with the microprocessor device 210. SPI 208 may comprise various components and may communicate with various signal paths. In an exemplary embodiment, the SPI 208 comprises shift registers for receiving and sending data via communication lines such as: Master In Slave Out and Master Out Slave In lines. The SPI 208 may further be configured to operate in either a master or slave mode.

As shown in FIG. 2, the vehicle data receiver 200 includes the microcontroller 210 that is connected to an interface 212. In certain embodiments the interface 212 is a High Speed Control Area Network (HSCAN) interface. Controller Area Network (CAN) was designed for automotive applications needing high levels of data and data rates of up to 1 Mbit/s. Beginning with the 2008 model year and beyond, this industry standard is the only acceptable communication protocol. CAN messages have a specified structure dictated by CAN standards. CAN networks have rules for dealing with colliding messages when two modules begin transmitting messages at the same time. HSCAN 214 is classified as a Class C network for both vehicle network and diagnostic communication. It is noted that HSCAN network 214 may be connected to a specialized OBD port which connects to modern vehicle powertrain CAN bus. In other words, the vehicle data receiver 200 is configured to acquire a plurality of government mandated and many manufacturer specific performance parameters using HSCAN network 214.

The wireless communication modules 216, 218 enable wireless communications over a variety of standards, including, but not limited to, Cellular (e.g., GSM, CDMA, GPRS, LTE), 802.11 (e.g., WLAN), and short range (e.g., Bluetooth, infrared, RFID), for the delivery of acquired vehicle performance data to remote data resources (e.g., cloud-based platform 125). In the embodiment depicted in FIG. 2, a first wireless communication module 216 comprises a Bluetooth module and a second wireless communication module 218 comprises a WiFi module. Furthermore, alternative embodiments may have just one or more than two wireless communication modules.

The Bluetooth module 216 can include any suitable combinations of hardware for performing wireless communications with other Bluetooth enabled devices and allows an RF signal to be exchanged between the head unit processor 202 and other Bluetooth enabled devices. In some embodiments, the Bluetooth module 216 can perform such wireless communications according to Bluetooth Basic Rate/Enhanced Data Rate (BR/EDR) and/or Bluetooth Low Energy (LE) standards. For example, the Bluetooth module 216 can include suitable hardware for performing device discovery, connection establishment, and communication based on only Bluetooth LE (e.g., single mode operation). As another example, the Bluetooth module 216 can include suitable hardware for device discovery, connection establishment, and communication based on both Bluetooth BR/EDR and Bluetooth LE (e.g., dual mode operation). As still another example, the Bluetooth module 216 can include suitable hardware for device discovery, connection establishment, and communication based only on Bluetooth BR/EDR. The WiFi module 218 can include any suitable combinations of hardware for performing WiFi (e.g., IEEE 802.11 family standards) based communications with other WiFi enabled devices.

In another aspect of this disclosure, a computer implemented method for recommending one or more fueling locations can include receiving, at a processor, vehicle data including at least one of fuel tank volume, fuel level, vehicle speed, vehicle load, fuel consumption rate, range, odometer reading, engine performance, vehicle performance history, one or more ambient conditions, vehicle make, vehicle model, specific drivetrain information, performance related vehicle modifications, an operator profile, location, or destination. The method can further include receiving, at the processor, one or more fuel properties of one or more batches of fuel from a fuel properties database, and providing a recommended fueling location to an operator of the vehicle based on the received vehicle data and the received one or more fuel properties to optimize vehicle performance.

Receiving vehicle data can include receiving a vehicle location and/or destination from a navigational system. In certain embodiments, the method can include providing a recommended fuel type and/or additive based on the vehicle data and/or the one or more fuel properties.

The method can include communicating with a fuel dispenser to send the recommended fuel type and/or additive to a fuel pump to cause the fuel pump to provide the vehicle with fuel having the recommended fuel type and/or additive. In certain embodiments, the dispenser or any other suitable data source can tell the vehicle and/or a user about fuel properties that may be taken advantage of at that location, e.g., Reid Vapor Pressure, Ethanol content for E85, or any other suitable property.

Providing a recommended fueling location can include providing one or more locations within a predetermined range of the vehicle based on fuel level and fuel consumption rate. Providing the recommended fueling location can include displaying one or more fueling locations on a graphical user interface (GUI). Displaying the one or more recommended fueling locations on a GUI can include displaying the one or more recommended fueling locations on a display of a navigational system of a vehicle or on a mobile device display.

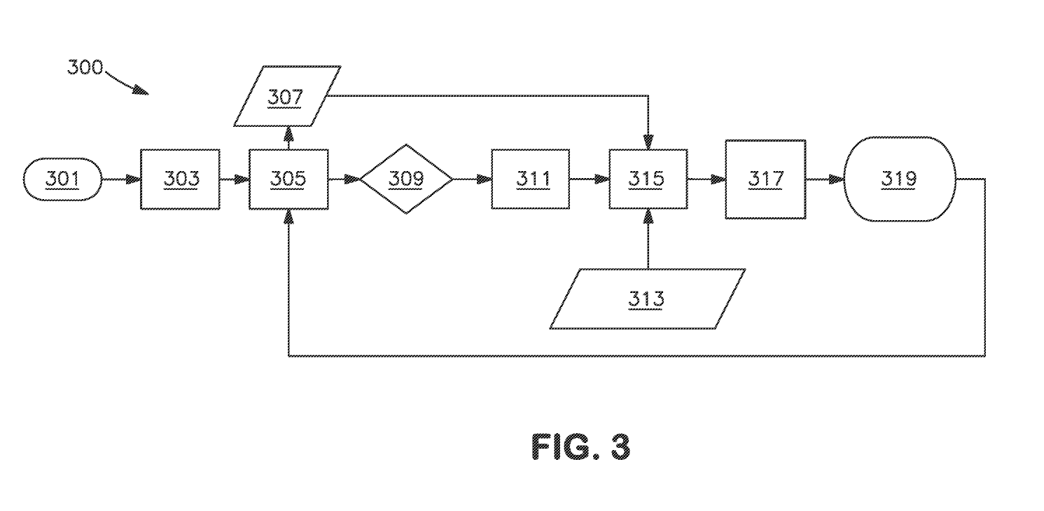

Referring additionally to FIG. 3, an embodiment of a method 300 is shown. First, the vehicle data receiver 106 is installed (e.g., at block 301) into the data port (e.g., J1962 port or J1939) or directly installed into the vehicle data system. In certain embodiments, a vehicle profile can be created and/or associated data (e.g., vehicle make, model, specific drivetrain information and performance related modifications) can be manually inputted (e.g., at block 303) into the vehicle data receiver 106 and/or sent directly to the recommendation module 114 (e.g., via a GUI on the user's mobile device).

Vehicle data such as fuel tank volume, speed, load, fuel consumption, odometer, performance history etc., can be read (e.g., at block 305) and/or logged (e.g., at block 307). An initial learning process can be utilized based on driver style, geolocation, topography, performance effects, and/or drivetrain performance for example. This information can be logged, stored, and transmitted to the recommendation module 114 for analysis.

The method 300 includes triggering a refueling event (e.g., at block 309). In certain embodiments, the user triggers a refuel event due to low fuel. It is contemplated the refueling event can be triggered automatically by the vehicle data device based a low fuel indication from the vehicle computer. General/specific destination information and/or load/weight can be uploaded (e.g., at block 311) to the recommendation module 114 and/or to the cloud to pull possible refuel locations with a predetermined range based on the destination/load information.

The properties of a fuel of certain batches of fuel (e.g., at specific refueling locations, on certain fuel trucks, or in certain storage areas) are provided (e.g., at block 313) to the recommendation module 114 from the fuel properties database.

At block 315, the recommendation module 114 receives vehicle data (e.g., location, performance, specifications) and/or destination data, and the fuel properties of various batches of fuel. The recommendation module then analyzes this data and can determine which batch 115 and/or fuel type is optimal to refuel at based to enhance performance and/or efficiency. Based on current location information, the recommendation module 114 suggests a refueling location and/or fuel type/additive and can direct the driver to the selected location (e.g., by providing a GPS location to a navigational system).

At the refueling station, the vehicle can communicate with the dispenser pump and request (e.g., at block 317) an optimized additive blend to upgrade the base fuel. The method 300 can then be repeated e.g., at block 319. The performance of the customized fuel can then be logged and uploaded to the cloud. This information can be added to the vehicle data and/or otherwise used to optimize future fuel customization recommended by recommendation module 114.

Fuel as described herein can be any suitable fuel (e.g., gasoline, diesel, alternative fuels). For example, while embodiments may be described in relation to petro fuels, this disclosure also extends to vehicles fueled with alternative fuels such as natural gas and/or dimethyl ether. For example, the composition of natural gas can vary in hydrocarbons, inert components and contaminates. These compositional variations can affect important properties of the fuel (e.g., the Wobbe index and methane number), which can affect the performance of a natural gas powered vehicle. Any other suitable fuels are contemplated herein. Any other suitable properties of any suitable fuel can be monitored and/or reported to the properties database as described above.

Embodiments as described above exploit the inherent variability in the fungible diesel/gasoline fueling system to create a customized fueling experience for consumers. Fuel properties indicated through advanced analysis can be uploaded to the cloud and customized fueling can be enhanced by recommending and guiding a vehicle to a specific batch of fuel at specific retail sites, based on the vehicle's performance history, destination and ambient conditions, for example. Fuel properties can be measured at the terminal, on the tanker truck, or in the retail sites fuel tank (i.e. the dispenser) through spectrum sensor technologies (e.g. infrared, impedance or mass spectrometry). Fuel can be customized through bottled additization or dispenser-based additization where specific additive blends are specified based on the vehicle's performance history, destination, and ambient conditions. Leveraging the variability by measuring/tracking fuel properties then directing consumers to a specific fuel batch, allows the monetization of this variability. Vehicle performance can be enhanced by utilizing vehicle performance parameters, driver behavior, local weather conditions, and vehicle location to recommend an optimized blend of additives.

The techniques described herein, improve the customer experience and facilitate prevention of damage to vehicles. Moreover, using the telematics data from a customer's vehicle, various fuel related recommendations or enhancements can be provided to the customer, as discussed above.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### PCT/EP Clauses:

1. A system for providing fuel location recommendations, the system comprising: a vehicle data receiver configured to receive vehicle data from a vehicle computer, navigational system, and/or a vehicle operator;

a fuel characteristic module configured to receive fuel properties of one or more fuel batches from a fuel property database; and
a recommendation module configured to determine one or more recommended locations for refueling the vehicle based on received vehicle data from the vehicle data receiver and received fuel properties from the fuel property database.

2. The system of clause 1, wherein the vehicle data includes at least one of fuel tank volume, fuel level, vehicle speed, vehicle load, fuel consumption rate, range, odometer reading, engine performance, vehicle performance history, one or more ambient conditions, vehicle make, vehicle model, specific drivetrain information, performance related vehicle modifications, an operator profile, location, or destination.

3. The system of clause 1 or 2, wherein the vehicle data receiver is configured to be connected to a data port of the vehicle.

4. The system of any of clauses 1-3, wherein the vehicle data receiver includes a memory and a processor configured to execute computer readable instructions on stored on the memory, wherein the fuel characteristic module and the recommendation module are software modules in the form of computer readable instructions stored on the memory of the vehicle data receiver and configured to be executed by the processor.

5. The system of any of clauses 1-4, wherein the vehicle data receiver is operatively connected to the navigational system to output a recommended fueling location to the navigational system to display the recommended fueling location to the vehicle operator.

6. The system of any of clauses 1-5, wherein the vehicle data receiver is configured to be wirelessly connected to a mobile device.

7. The system of any of clauses 1-6, wherein the fuel characteristic module and the recommendation module are software modules in the form of computer readable instructions stored on a memory of the mobile device wherein the recommendation module is configured to output a recommended fueling location to a mobile navigational system of the mobile device.

8. The system of any of clauses 1-7, wherein the fuel properties database is stored on a remote server and/or in the cloud and is updated in real time.

9. A system for recommending fueling locations to a user of a vehicle, comprising:

a plurality of fuel property sensors disposed in a plurality of locations, each sensor operatively configured to sense at least one of a fuel quality of a batch of fuel or an ambient condition around or near the batch of fuel, wherein the sensors are communicatively connected to a fuel property database to output the fuel quality and/or ambient condition to the fuel property database.

10. The system of clause 9, comprising a server including a server processor and a server memory, wherein the fuel property database is stored on the server memory, wherein the server processor is communicatively connected to the plurality of fuel property sensors.

11. The system of clause 9 or 10, wherein the fuel property database is stored on the cloud and each sensor is connected to the internet.

12. A computer implemented method for recommending one or more fueling locations, comprising:

receiving, at a processor, vehicle data including at least one of fuel tank volume, fuel level, vehicle speed, vehicle load, fuel consumption rate, range, odometer reading, engine performance, vehicle performance history, one or more ambient conditions, vehicle make, vehicle model, specific drivetrain information, performance related vehicle modifications, an operator profile, location, or destination;
receiving, at the processor, one or more fuel properties of one or more batches of fuel from a fuel properties database; and
providing a recommended fueling location to an operator of the vehicle based on the received vehicle data and the received one or more fuel properties to optimize vehicle performance.

13. The method of clause 12, wherein receiving vehicle data further includes receiving a vehicle location and/or destination from a navigational system.

14. The method of clause 12 or 13, further comprising providing a recommended fuel type and/or additive based on the vehicle data and/or the one or more fuel properties.

15. The method of any of clauses 12-14, further comprising communicating with a fuel dispenser to send the recommended fuel type and/or additive to a fuel pump to cause the fuel pump to provide the vehicle with fuel having the recommended fuel type and/or additive.

16. The method of any of clauses 12-15, wherein providing a recommended fueling location includes providing one or more locations within a predetermined range of the vehicle based on fuel level and fuel consumption rate.

17. The method of any of clauses 12-16, wherein providing the recommended fueling location includes displaying one or more fueling locations on a graphical user interface (GUI).

18. The method of any of clauses 12-17, wherein displaying the one or more recommended fueling locations on a GUI includes displaying the one or more recommended fueling locations on a display of a navigational system of a vehicle or on a mobile device display.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system for providing fuel location recommendations, the system comprising:
a vehicle data receiver configured to receive vehicle data from a vehicle computer, navigational system, and/or a vehicle operator;
a fuel characteristic module configured to receive fuel properties of one or more fuel batches from a fuel property database; and
a recommendation module configured to determine one or more recommended locations for refueling the vehicle based on received vehicle data from the vehicle data receiver and received fuel properties from the fuel property database.

2. The system of claim 1, wherein the vehicle data includes at least one of fuel tank volume, fuel level, vehicle speed, vehicle load, fuel consumption rate, range, odometer reading, engine performance, vehicle performance history, one or more ambient conditions, vehicle make, vehicle model, specific drivetrain information, performance related vehicle modifications, an operator profile, location, or destination.

3. The system of claim 1, wherein the vehicle data receiver is configured to be connected to a data port of the vehicle.

4. The system of claim 3, wherein the vehicle data receiver includes a memory and a processor configured to execute computer readable instructions on stored on the memory, wherein the fuel characteristic module and the recommendation module are software modules in the form of computer readable instructions stored on the memory of the vehicle data receiver and configured to be executed by the processor.

5. The system of claim 4, wherein the vehicle data receiver is operatively connected to the navigational system to output a recommended fueling location to the navigational system to display the recommended fueling location to the vehicle operator.

6. The system of claim 3, wherein the vehicle data receiver is configured to be wirelessly connected to a mobile device.

7. The system of claim 6, wherein the fuel characteristic module and the recommendation module are software modules in the form of computer readable instructions stored on a memory of the mobile device wherein the recommendation module is configured to output a recommended fueling location to a mobile navigational system of the mobile device.

8. The system of claim 4, wherein the vehicle data receiver is configured to be wirelessly connected to a mobile device.

9. The system of claim 1, wherein the fuel properties database is stored on a remote server and/or in the cloud and is updated in real time.

10. A system for recommending fueling locations to a user of a vehicle, comprising:
a plurality of fuel property sensors disposed in a plurality of locations, each sensor operatively configured to sense at least one of a fuel quality of a batch of fuel or an ambient condition around or near the batch of fuel, wherein the sensors are communicatively connected to a fuel property database to output the fuel quality and/or ambient condition to the fuel property database.

11. The system of claim 10, comprising a server including a server processor and a server memory, wherein the fuel property database is stored on the server memory, wherein the server processor is communicatively connected to the plurality of fuel property sensors.

12. The system of claim 8, wherein the fuel property database is stored on the cloud and each sensor is connected to the internet.

13. A computer implemented method for recommending one or more fueling locations, comprising:
receiving, at a processor, vehicle data including at least one of fuel tank volume, fuel level, vehicle speed, vehicle load, fuel consumption rate, range, odometer reading, engine performance, vehicle performance history, one or more ambient conditions, vehicle make, vehicle model, specific drivetrain information, performance related vehicle modifications, an operator profile, location, or destination;
receiving, at the processor, one or more fuel properties of one or more batches of fuel from a fuel properties database; and
providing a recommended fueling location to an operator of the vehicle based on the received vehicle data and the received one or more fuel properties to optimize vehicle performance.

14. The method of claim 13, wherein receiving vehicle data further includes receiving a vehicle location and/or destination from a navigational system.

15. The method of claim 13, further comprising providing a recommended fuel type and/or additive based on the vehicle data and/or the one or more fuel properties.

16. The method of claim 15, further comprising communicating with a fuel dispenser to send the recommended fuel type and/or additive to a fuel pump to cause the fuel pump to provide the vehicle with fuel having the recommended fuel type and/or additive.

17. The method of claim 13, wherein providing a recommended fueling location includes providing one or more locations within a predetermined range of the vehicle based on fuel level and fuel consumption rate.

18. The method of claim 17, wherein providing the recommended fueling location includes displaying one or more fueling locations on a graphical user interface (GUI).

19. The method of claim 18, wherein displaying the one or more recommended fueling locations on a GUI includes displaying the one or more recommended fueling locations on a display of a navigational system of a vehicle or on a mobile device display.
